(19) United States
(12) Patent Application Publication
(10) Pub. No.: US 2017/0299775 A1
(43) Pub. Date: Oct. 19, 2017

(54) DEVICE AND METHOD FOR SCREEN PROTECTION

(71) Applicants: Vicki Hamberg, Tacoma, WA (US); Todd Hagmann, Tacoma, WA (US)

(72) Inventors: Vicki Hamberg, Tacoma, WA (US); Todd Hagmann, Tacoma, WA (US)

(21) Appl. No.: 15/446,326

(22) Filed: Mar. 1, 2017

Related U.S. Application Data
(63) Continuation-in-part of application No. 14/493,105, filed on Sep. 22, 2014, now abandoned.

(51) Int. Cl. G02B 1/11; G02F 1/01; G02B 1/18

(52) U.S. Cl. CPC G02B 1/11; G02B 1/18; G02F 1/0126

(57) ABSTRACT

An image converting screen protector for displaying an illustration on a display screen of a portable electronic device when the screen is off and becoming transparent when the screen is on. The image converting screen protector comprises a modified screen protector having top shield layer and a screen layer. The top shield layer is optically transparent and the screen layer toggles between an opaque condition and a clear condition.

### BACKGROUND OF THE INVENTION

### Field of the Invention

The present invention relates to screen protection for a mobile device where the screen protector has includes two layers one capable of toggling between an opaque condition and a clear condition.

### Description of the Prior Art

The use of conventional screen protectors to place on the display screen of various handheld devices, such as mobile phones or tablet computers is well known. Such screen protectors are commonly thin plastic bodies having an adhesive side and are generally clear or tinted to enable the images on the screen to be easily seen while the screen protector is in place over the screen. A problem which still exists, however, is that existing screen protectors generally are not useful to add a unique style or finish to the handheld devices as it remains paramount that they enable full visibility of the screen. Thus, there remains a need for an image converting screen protector that includes an integrated illustration, defined as a selected design and/or text, without affecting the visibility of the screen it is placed on. It would be additionally desirable for such an image converting screen protector included at least two layers to ensure only light from the screen caused the color change to clear.

The Applicant's invention described herein provides for an image converting screen protector adapted to provide a visible image on a screen protector that clears when the screen is in use. The primary components in Applicant's an image converting screen protector are a screen layer and top protective shield layer disposed over the screen layer.

### SUMMARY OF THE INVENTION

An image converting screen protector for displaying an illustration in a first state and dissolving visibility in a second state. The screen protector is place over a screen of a portable electronic device where the screen toggles between an illuminated state and non-illuminated state. When the screen is illuminated the screen protector is transparent conversely when the screen is off or non-illuminated then the screen protector depicts a preset image. The image converting screen protector comprises a modified screen protector having top shield layer and a screen layer. The top shield layer is optically transparent and the screen layer converts between an opaque condition displaying an image to a non-opaque condition providing visibility of the illuminated screen. The image converting screen protector attaches to the display screen of a mobile phone, displaying design, and/or text in the screen layer when the display screen is off and being optically transparent when the display screen is on.

It is an object of this invention to provide an image converting screen protector that includes an integrated illustration without affecting the visibility of the screen it is placed on.

It is yet another object of this invention to provide an image converting screen protector that utilizes a plurality of layers to ensure only light from the screen causes the desired color change.

These and other objects will be apparent to one of skill in the art.

### BRIEF DESCRIPTION OF THE DRAWINGS

FIG. 1 is a side perspective view of a mobile phone having an image converting screen protector built in accordance with the present invention disposed thereon with its display screen off.

FIG. 2 is a front elevational view of an image converting screen protector built in accordance with the present invention disposed thereon with no light behind it.

FIG. 3 is a side perspective view of a mobile phone having an image converting screen protector built in accordance with the present invention disposed thereon with its display screen on.

FIG. 4 is a front elevational view of an image converting screen protector built in accordance with the present invention disposed thereon with light behind it.

FIG. 5 is a side elevational view of an image converting screen protector built in accordance with the present invention.

### DETAILED DESCRIPTION OF THE INVENTION

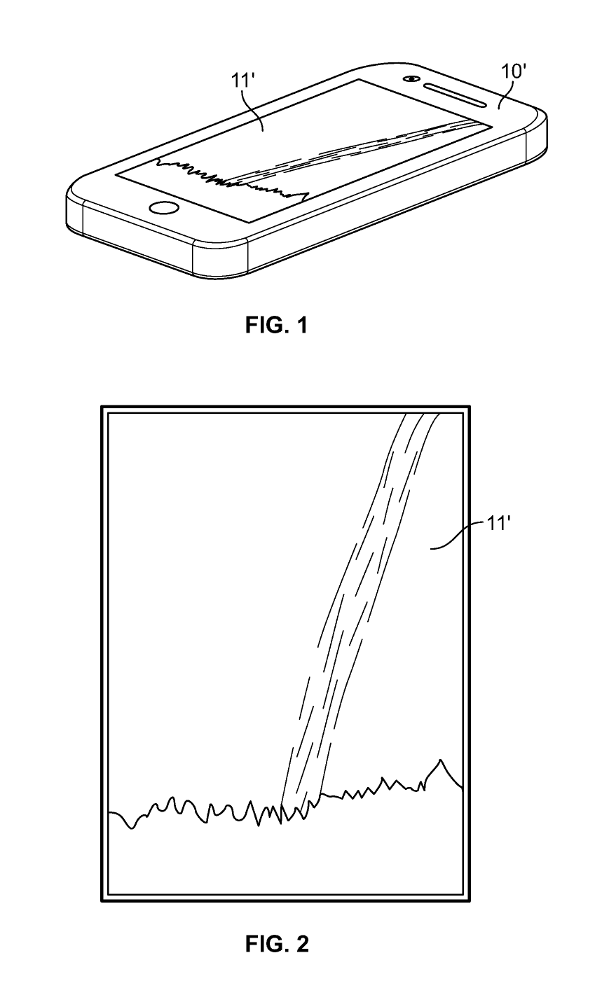

Referring now to the drawings and FIGS. 1 and 2, an image converting screen protector 11′ is shown disposed over a display screen of a conventional mobile phone 10′ with its display screen off. The image converting screen protector 11′ attaches to the display screen of the mobile phone 10′ in the same manner(s) as conventional screen protectors. In the preferred embodiment, the image converting screen protector 11′ attaches to the display screen using an adhesive.

When the display screen of the mobile phone 10′ is off, with no light emanating therefrom, the image converting screen protector 11′ includes an integrated illustration that is visible to the naked eye. It is contemplated that the integrated illustration on any image converting screen protector 11′ may be substantially any image, design, and/or text that can be created solely using photochromic paint, dye, and/or ink.

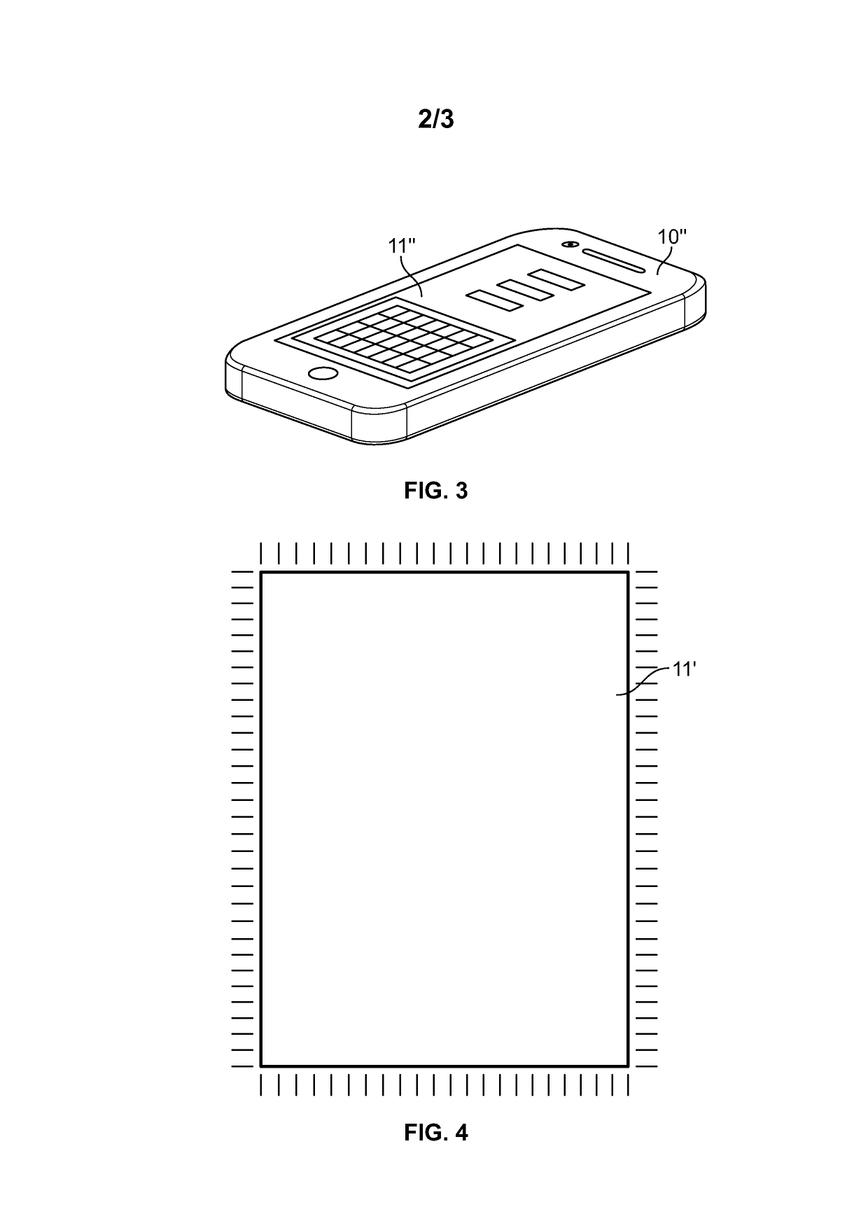

Referring now to FIGS. 3 and 4, when the image converting screen protector 11″ is disposed on the display screen of a conventional mobile phone 10″ with its display screen on and therefore emitting light and prompting the image converting screen to toggle to a clear condition. As such, when the display screen is being used, as determined by the emission of light therefrom, the image converting screen protector 11″ becomes clear and allows an unobstructed view of the display screen.

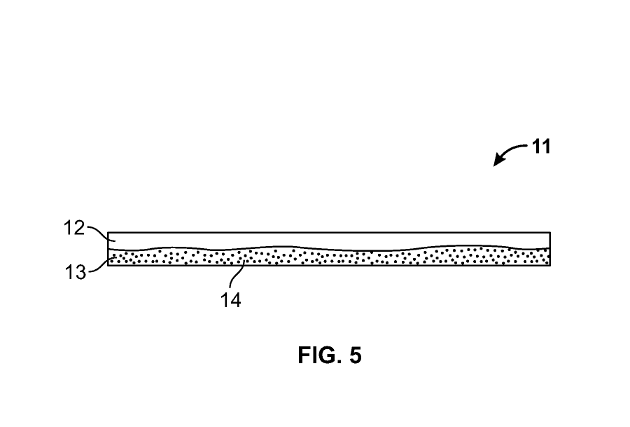

Referring now to FIGS. 1, 2, 3, 4, and 5, the image converting screen protector 11′, 11″ in accordance with the present invention (collectively 11) includes a top shield layer 12 and a screen layer 13. The top shield layer 12 is clear, containing no material that will impair viewing of a screen therethrough. The screen layer 13 is the layer that is placed closest to the display screen of the handheld device when the image converting screen protector 11 is in use. The screen layer 13 includes therein an integrated illustration. It is contemplated that the top shield layer 12 is optically transparent, reflecting minimal light to enable the display screen to be visible therethrough but also preventing ambient light from interacting sufficiently with the screen layer 13.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An image converting screen protector for placement on a display screen of a portable electronic device, comprising:
a. a screen layer, where the screen layer adheres to the display screen; and
b. a top protective layer constructed of optically transparent material, wherein the screen layer is adapted to toggle between an opaque condition display a visible image through the top protective layer and and clear condition enable a view of the display screen and said clear condition is triggered when exposed to light emitted by the display screen.

2. A method of protecting a display screen of a portable electronic device comprising the steps of:
a. joining a first layer with a second layer;
b. integrating variable image into the first layer;
c. adhering the first layer to the display screen;
d. enabling two states for the first layer, an opaque condition and a clear condition; and
e. activating the clear condition upon light emission from the display screen.

3. The method according to claim 2, where the opaque condition displays the variable image of the first layer.

4. The method according to claim 2, where the display screen is visible in the clear condition.

5. The method according to claim 2 further including the step of integrating protective qualities into the second layer.

6. The method according to claim 2 further includes integrating a transparent material into the second layer.
